(19) United States
(12) Patent Application Publication
(10) Pub. No.: US 2011/0130905 A1
(43) Pub. Date: Jun. 2, 2011

(54) Remote Vehicle Monitoring and Diagnostic System and Method

(75) Inventor: Frank S. Mayer, San Diego, CA (US)

(73) Assignee: ISE CORPORATION, Poway, CA (US)

(21) Appl. No.: 12/628,776

(22) Filed: Dec. 1, 2009

(51) Int. Cl. G06F 17/00; B60Q 1/00; G01M 17/00; B60K 6/20

(52) U.S. Cl. 701/22; 340/439; 701/29; 180/65.21

(57) ABSTRACT

A vehicle monitoring system and method has a vehicle unit which is mounted in each vehicle and a remote monitoring and diagnostic server or system which receives periodic status information in messages from the vehicle units of all active vehicles and displays the data in a user interface on one or more user devices. The vehicle unit is configured to send periodic first messages containing a first, partial set of vehicle operation status information and periodic second messages containing a second, larger set of status information, and may be switched to send second messages at faster time intervals depending on various conditions. The user interface displays at least part of the second set of vehicle information for a selected vehicle while displaying at least part of the first set of vehicle information for at least some active vehicles sending messages to the remote server.

### BACKGROUND

1. Field of the Invention

The present invention relates generally to remote vehicle status monitoring and diagnostics, and is particularly concerned with a vehicle status monitoring and diagnostic system and method for a fleet of vehicles in which status data for each vehicle is collected and transmitted to a remote monitoring and diagnostics station or operator station.

2. Related Art

Vehicle telematics is a term used to define communicatively connected vehicles interchanging electronic data. These systems are used for a number of purposes, including collecting road tolls, managing road usage (intelligent transportation systems), pricing auto insurance, tracking fleet vehicle locations (fleet telematics), cold store logistics, recovering stolen vehicles, providing automatic collision notification, location-based driver information services. For example, General Motors' OnStar is an in-vehicle safety and security system created to help protect drivers on the road. OnStar touts an innovative three-button system that offers: 24-hour access to trained advisors, a connection to emergency assistance, and access to OnStar Hands-Free Calling.

While there are many applications for vehicle telematics, fleet telematics are of particular interest here. Fleet operators commonly use vehicle telematics systems and vehicle tracking for fleet management functions such as routing, dispatch, and on-board information and security. In tracking the vehicle or its cargo, communication is enabled between the vehicle and central station that has applications such as vehicle tracking software, programmed to monitor such aspects of travel as location, speed, and driver behavior.

A Fleet Telematics System (FTS) allows the information exchange between a commercial vehicle fleet and their central station, (e.g., the dispatching office or a transit authority). A FTS consists of mobile Vehicle Systems (VS) and a stationary Fleet Communication System (FCS). The FCS is a stand alone application maintained by the vehicle manufacturer or an internet service running by the supplier of the system. The communication with the FCS is realized by trunked radio, cellular, or satellite communication. Positioning of vehicles is also realized by satellite positioning systems and/or dead reckoning using gyroscope and odometer. Fleet Operators benefit from commercial vehicle telematics as they provide a useful, cost-saving, and liability limiting, logistics management tool for commercial fleets that transport goods or people.

Also of particular interest are remote diagnostics. Vehicle telematics systems have also be used in a limited fashion to diagnose or report a problem of the vehicle. In particular, a vehicle's built-in system will identify a mechanical or electronic problem, and, in response, the telematics package can report the problem. The telematics monitored system is also capable of notifying any problems to the owner of the vehicle via e-mail.

With the emergence of more complex vehicular systems such as over-the-road heavy-duty hybrid vehicles, there is a need for a more comprehensive, yet efficient telemetry system. This is particularly true for common carriers, which have an increased need for real-time information. However, with vehicle fleets having many vehicles, real-time solutions involve costly consumption of wireless radio bandwidth. It is therefore an object of the presently claimed invention to provide a system and method for efficient remote diagnostic and monitoring fleet communications of many related vehicles (e.g., a vehicle fleet).

In addition, while heavy duty hybrid drive systems may provide greater fuel efficiency than conventional vehicles, they include multiple subsystems and components having a higher interdependence. As such, a hybrid electric drive system may be less tolerant of subsystem or component failures that their conventional counterparts. Also, given that hybrid drives are predominately electrical, as opposed to mechanical, transient faults and/or failures occurring during operation are often less detectable at the end of the vehicle's drive cycle.

### SUMMARY

Embodiments described herein provide for collection of vehicle operation and location information from active vehicles in a fleet of vehicles and transmission of collected data to a fleet monitoring station or server in two different status messages containing different amounts of information for use in vehicle status monitoring and diagnostics. The system and method may be used for fleets or groups of hybrid electric or electric vehicles, or vehicles with gas engines, or for fleets which include vehicles with different types of engines. The present disclosure may be used advantageously by hybrid manufacturers, operators, and service personnel alike for troubleshooting drive systems problems, monitoring vehicle performance, continuously improving designs, etc.

According to one aspect, a computer implemented method of remotely monitoring the status and performing diagnostics on a plurality of vehicles is provided, which comprises communicating collected vehicle status information from a plurality remote diagnostic units (RDUs) in active vehicles to a central monitoring station, the step of communicating collected vehicle information from each vehicle comprising collecting component and sensor data from a plurality of components in the vehicle at the RDU in the vehicle and transmitting the data from the RDU to the central monitoring station in first status messages comprising a first group of vehicle information items and second status messages comprising a second, larger group of vehicle information items, displaying a list comprising identifiers for at least some active or online vehicles along with at least some of the first group of information items on a user interface and displaying at least some of the second group of information items for one of the active vehicles on the user interface.

In one embodiment, key status messages are transmitted at predetermined time intervals to the central monitoring station for display to a user, while full status messages for one vehicle, which may be a vehicle currently selected by the user, are transmitted at shorter time intervals to update the display for that vehicle on the user interface. Thus, the central monitoring station or remote server continuously receives selected basic information on all vehicles equipped with remote processing or diagnostic units which are currently on-line, while receiving more detailed information on any user-selected vehicle, and the basic information for at least some vehicles and detailed information on the user-selected vehicle are displayed together on the user interface and updated each time a new set of information is received.

In one embodiment, the RDUs or the remote server may be configured to detect a specific vehicle related event or fault, and to take action when the event is detected for any currently active vehicle. The vehicle event in one embodiment may be a failure or fault detected from information collected from the vehicle or a failure/fault flag sent in a status message from the vehicle. The action taken on detection of the vehicle event may be to send a message to a user or to the vehicle driver, or to request additional information from the vehicle or a component in the vehicle affected by the event. Additionally, the user interface may be switched from showing complete or more detailed information on the user-selected vehicle to showing detailed information from second status messages on the vehicle in which the vehicle related event occurred, or a message may be sent from the remote server to the user or manager asking if they wish to switch to showing a more detailed display of information for the affected vehicle. In one method, the vehicle related event is a detected fault or failure. In this embodiment, the RDU detecting failures or faults may be configured to send a failure/fault message to the central processing station, to increase the data transmission rate or increase an information sampling rate for the detected failed or faulty vehicle component, and/or actively request additional status information from the component via a controller communication link. The central processing station may be programmed to switch automatically to display more detailed information from the second status messages on the failed/faulty vehicle as the selected vehicle on the user interface or GUI.

The detailed vehicle information on a selected vehicle displayed on the user interface may include some or all of the following:
a. Hybrid drive system fault/failure,
b. Propulsion Energy Storage Overvoltage
c. Propulsion Energy Storage State of Health (SOH) or State of Charge (SOC),
d. Electrical System Isolation Resistance,
e. Vehicle Location, Speed, or Fuel Economy or average miles per gallon (mpg),
f. Number of Passengers or Vehicle Revenue,
g. Vehicle sensors output,
h. Fuel level (e.g. H2)
i. Status of particular vehicle components of interest such as generators, inverters, energy storage modules, electric motors, fuel cell, engine, and the like.

The reported information may be processed at the remote server and may be fed back to the vehicle to determine additional information, to provide feedback of processed information or calculated information to the vehicle, or to trigger a command to be issued. For example, the system may receive an odometer reading as part of the vehicle information, compare it to the mileage on the vehicle's route (e.g. a bus route), and send an appropriate message to the driver if there is an inconsistency between the odometer reading and the expected mileage. Fuel economy data may also be used to adjust or reconfigure the vehicle's engine automatically if there is an inconsistency from what is expected.

According to another aspect, a remote vehicle monitoring and diagnosis system is provided which comprises a plurality of remote diagnostic units (RDUs) configured for installation in respective vehicles in an associated group of vehicles, a central diagnostic station or remote server for receiving vehicle data from all currently active vehicles in the group via one or more networks, and at least one user device having a display unit for displaying vehicle information to a user. In one embodiment, each RDU comprises a first communication module which communicates with engine and other vehicle components and sensors over a communication channel or bus of a vehicle CAN (controller area network) to receive data from those components, a data storage unit which stores vehicle data, a second communication module which communicates with the remote server over one or more networks, and an RDU control or processing module which is configured to control communications with the vehicle components and with the remote server. The processing module is configured to receive selected vehicle information data and send different groups of the vehicle information to the remote server in periodic first and second status messages.

The monitoring station or remote server in one embodiment basically comprises an RDU communication module configured to communicate with all currently active vehicle RDUs, a control module configured to control the communication module to send command messages to selected RDUs and to receive vehicle status messages from all currently active RDUs, a data storage module to store vehicle status information, and a client communication module configured to send predetermined first and second vehicle status messages to one or more user or client devices. The first messages may contain all of the information received in the first status messages from the vehicles, or only selected information from the first status messages. The information in the first status messages may comprise user selected information items which may be different for different user devices. A graphical user interface (GUI), module at the remote server or user device is configured to display a selected subset of status information for at least some currently active vehicles retrieved from the first status messages and to display a larger amount of information from the second status messages of one vehicle. The vehicle RDU or the remote server may include a failure detection or diagnostic module which monitors data received from currently active vehicles to detect failures or faults in any vehicle components.

In one embodiment, the RDU control module is configured to control the second communication module to send all status information for an active vehicle currently selected by a user at the central diagnostic station at a first data rate or time interval, and to send selected status information for all other currently active vehicles at a second, slower data rate.

The first status message of all active vehicles may include a system failure/fault flag in the event of a failure or fault, and the system may be configured to display an additional alert to the user in the event that a failure/fault flag is present, which may include a message asking if the user wants to switch to the failed/faulty vehicle for full reporting. Alternatively, the system may automatically switch to the failed/faulty vehicle as the selected vehicle.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a block diagram illustrating one embodiment of a vehicle monitoring and diagnostic system for monitoring operation and status of a plurality of active vehicles in a fleet or the like;

FIG. 2A is a more detailed block diagram illustrating communications between one remote diagnostic unit (RDU) and one user device via the RDS server of FIG. 1;

FIG. 2B is a more detailed block diagram of one embodiment of the vehicle communication bus of FIG. 2A;

FIG. 3A is a block diagram illustrating communication between an RDU and individual vehicle components via the vehicle communication channel in each vehicle of the system of FIG. 1;

FIG. 3B is a more detailed block diagram of one embodiment of the virtual turnstile unit of FIG. 3A;

FIG. 4 is a more detailed block diagram of one embodiment of the fleet monitoring and diagnostic system (RDS) server at the operator/controller end of the system of FIG. 1;

FIG. 5 is a more detailed block diagram of one embodiment of the RDS client device installed in user devices of the system of FIG. 1;

FIG. 6 is a simplified example of a screen shot illustrating vehicle status information displayed on a user interface at a user device or monitoring station using the system of FIGS. 1 to 6;

FIG. 7 illustrates an alternative, user-selectable screen shot illustrating selected vehicle information displayed in a different configuration on the user interface;

FIGS. 9A and 9B are flow diagrams illustrating one embodiment of a method of vehicle monitoring and diagnosis using the system of FIGS. 1 to 6; and

FIG. 10 is a flow diagram illustrating one embodiment of a diagnostic method for monitoring for vehicle faults and failures.

### DETAILED DESCRIPTION

Certain embodiments as disclosed herein provide for a remote fleet vehicle status monitoring and diagnostic system and method in which a fleet operator or manager, maintenance personnel, or the like, can monitor the status and/or performance of all currently operating vehicles in a set or fleet of vehicles and receive selected key status information/items on all currently operating vehicles along with more detailed or complete status and/or performance information on any selected vehicle, which may be a user or operator selected vehicle from the active list, or a vehicle currently indicating a failure or fault condition.

After reading this description it will become apparent to one skilled in the art how to implement the invention in various alternative embodiments and alternative applications. However, although various embodiments of the present invention are described herein, it is understood that these embodiments are presented by way of example only, and not limitation. As such, this detailed description of various alternative embodiments should not be construed to limit the scope or breadth of the present invention as set forth in the appended claims.

In embodiments of the invention, the systems and methods described below are for remotely monitoring and diagnosing a plurality of electric drive systems in electric or hybrid electric drive vehicles (e.g., HEVs, EVs), especially in heavy-duty electric drive vehicles (e.g., heavy-duty HEVs, heavy-duty EVs) and heavy-duty electric drive vocational vehicles. While the claimed invention is directed toward EVs and HEVs (hereinafter “HEVs”), the present disclosure may be extended to other vehicles or groups of vehicles. As used herein, a heavy-duty electric drive vehicle is an electric drive vehicle having a gross weight of over 8,500 lbs. A heavy-duty HEV will typically have a gross weight of over 10,000 lbs. and may include vehicles such as a metropolitan transit bus, a refuse collection truck, a semi tractor trailer, or the like. Vocational vehicles may include heavy-duty single and tandem drive axles be used in vocational applications such as construction, heavy hauling, mining, logging, oil fields and refuse.

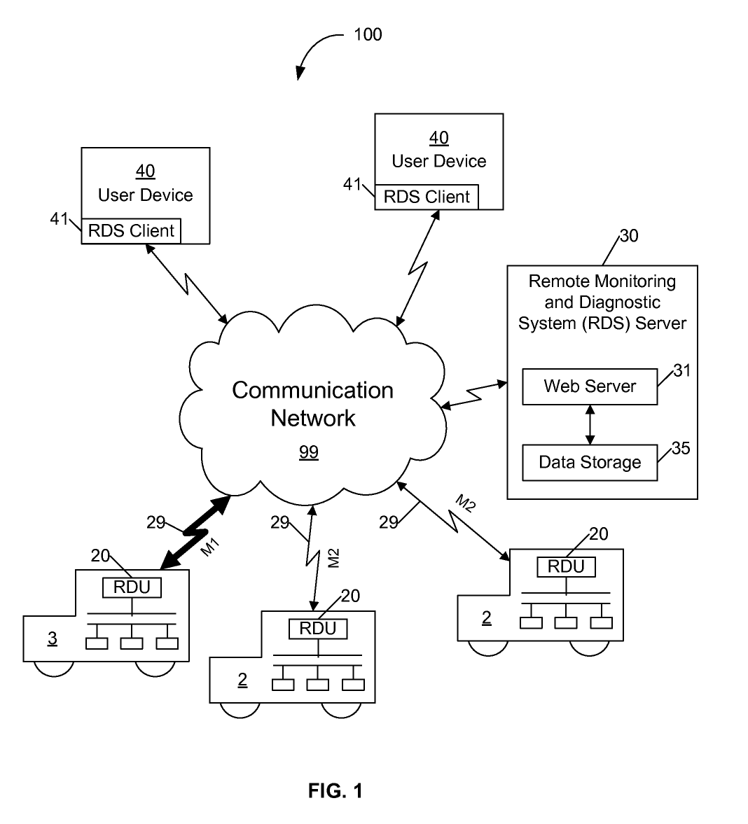

FIGS. 1 to 6 illustrate one embodiment of a system 100 for monitoring a plurality of hybrid electric drive systems installed in a fleet of vehicles 2, 3. Referring to FIG. 1, a fleet of three vehicles 2, 3 is illustrated for simplicity, however it is understood that a fleet may include many more vehicles (typically on the order of tens to hundreds). In addition, a fleet may be segregated by operator. For example, a particular hybrid drive system manufacturer may support a fleet of hundreds of vehicles, whereas individual operators/customers may only own fleets that consist of subsets of these vehicles (sub-fleets). As such, the present disclosure may be applied to an entire fleet and/or to sub-fleets. The fleet vehicles may be any type of vehicle including an electric and/or hybrid electric drive system communicably coupled to a vehicle communication bus. Preferably the fleet vehicles include heavy duty HEVs, and/or vocational vehicles, as described above. The EV's/HEV's may be powered by various power plants, e.g., internal combustion engines (ICEs)—such as conventional gas fueled engines, fuel cells, battery packs, etc. According to one alternate embodiment, the teachings of the present disclosure may also be applied to the drive systems of conventional vehicles and/or to merely the vehicle systems and components alone.

In the illustrated embodiment, the system 100 has a “vehicle side” comprising a plurality of vehicles 2, 3, and a user or “backend side” comprising a remote monitoring and diagnostic system (RDS) server or computer (“central monitoring station”) 30 and one or more user devices 40 having RDS client modules or RDS software 41, which communicates with the RDS server 30. The central monitoring station 30 and user device(s) 40 may be combined or separate. Fleet vehicles 2, 3 are all in wireless communication with the central monitoring station 30, however “selected” vehicle 3 is in a higher priority of communication than “non-selected” vehicles 2 (discussed below).

The system 100 further includes one or more communication networks 99, having one or more wireless links 29 for communications with vehicles 2, 3. The user devices 40 may be mobile or at remote locations, or may be a part of a computer system at a fleet management office. Each user device 40 is installed with software and/or hardware 41 for implementing the monitoring and diagnostic system and communicating with server 30 and vehicles 2, 3. RDS server 30 comprises one or more web servers 31 and associated data storage module or modules 35.

The one or more vehicles 2, 3, the server 30, and the one or more user devices 40 are all communicatively coupled via one or more networks 99. The network 99 includes a wireless network, which may include one or more wireless base stations (not illustrated). The network 99 is configured for communications over a wide geographical area and can be communicatively coupled with one or more public or private networks (not shown), which may include the aggregation of networks commonly known as the Internet.

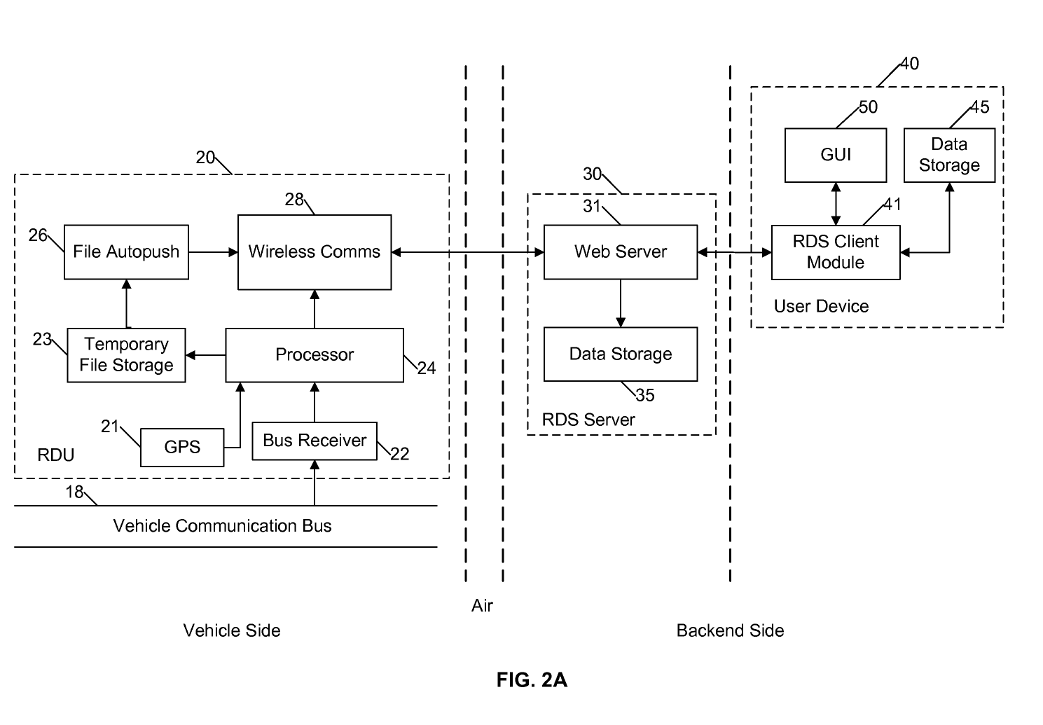

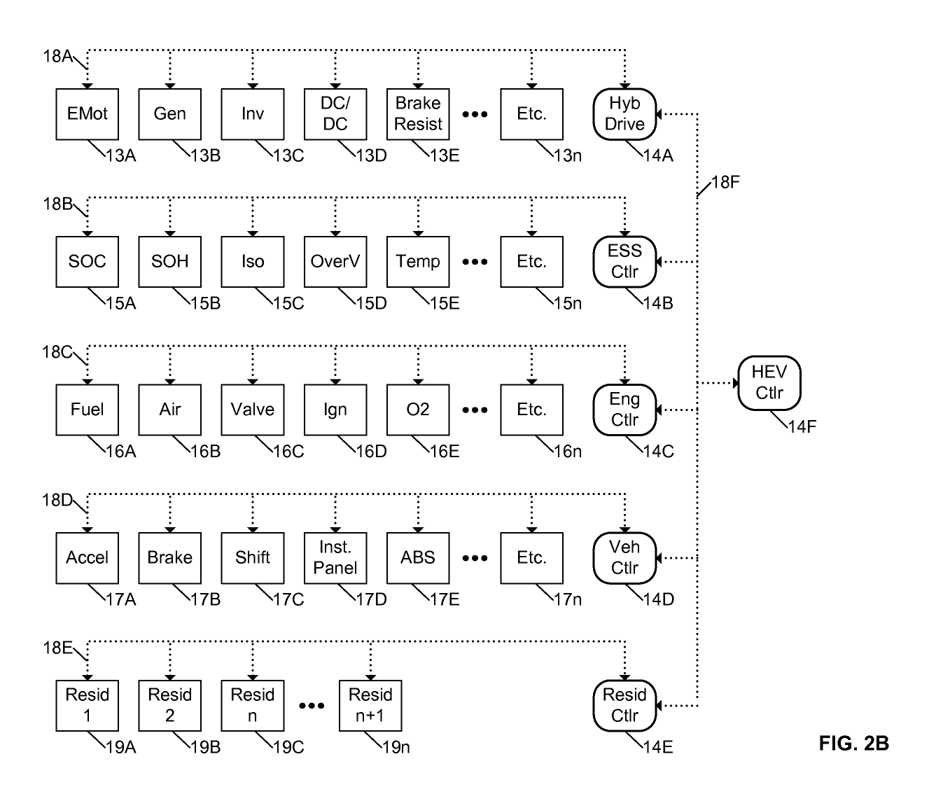

The vehicles 2, 3, the server 30, and the user devices 40 may be configured with data storage areas or storage devices 25, 35, 45, respectively (see also, FIG. 2). The data storage areas 25, 35, 45 can be any sort of internal or external memory device and may include both persistent and volatile memories. The function of the data storage area 35 at RDS server 30 is to maintain data, such as data relating to the operations of the vehicles, for long-term and short-term storage and also to provide efficient and fast access to instructions for applications that are executed by server 30.

The one or more user devices 40 can be implemented using a conventional computer system or other communication devices with the ability to communicate over a network, and may be mobile or stationary units. The user devices 40 may include one or more of mobile stations, wireless communication devices, mobile units, personal digital assistants (“PDA”), personal computers (“PC”), laptop computers, wired or wireless telephones, wired or wireless email devices, PC cards, special purpose equipment, subscriber stations, wireless terminals, personal media players, handheld devices or the like. In some embodiments, one or more of the user devices 40 may be, for example, a wireless handheld device, a vehicle mounted device, a portable device, client premise equipment, a fixed location device, wireless plug-in accessory or the like or any combination of these and other devices capable of establishing a communication link over network 99 with the server 30 and vehicles 2, 3. In some implementations, RDS client modules or software 41 installed on the one or more user devices 40 may be configured to implement a user interface or graphical user interface (GUI) 50 on a user's browser (FIG. 2) that is supported by the server 30. The user devices 40 may be operated by users such as engineers, fleet operators, maintenance personnel, and the like to determine real time operational vehicle status and other information which may be used for fleet operations monitoring, diagnostic purposes, report generation and the like, as described in more detail below. In addition the user devices 40 may be operated by users to access logged vehicle data.

FIG. 2A shows a more detailed block diagram illustrating communications between one remote diagnostic unit (RDU) 20 and one exemplary user device 40 via the RDS server of FIG. 1. As illustrated, the vehicle monitoring and diagnostic system has a “vehicle side” and a “backend side”. The vehicle side comprises a RDU 20 installed in the HEV, which communicates the vehicle's drive system (and other) information to the RDS server 30. The backend side comprises the RDS server 30 and the user device 40. The RDS server 30 transmits, records, and/or analyzes vehicle operation information and other vehicle information and statistics received from the vehicle side, and provides vehicle data to the user device 40. The user device 40 displays the vehicle information to a user and provides an interface for certain user commands to be sent to the HEV.

Referring to the vehicle-side's functional components, RDU 20 comprises a vehicle communication bus receiver 22 (e.g., CAN bus interface), a location determination module 21 (e.g., global positioning system (GPS)), a processor or control module 24, a temporary file storage 23 (e.g., flash memory), a file autopush module 26, and a remote diagnostic system (RDS) communication module 28, which may include a cellular transceiver and/or a point-to-point (PPP) communication protocol module. Module 28 may wirelessly communicate with RDS server 30 via cellular base stations (not illustrated) over one or more cellular and/or other communication networks. In one embodiment, RDU 20 may also include a failure/fault diagnostic module (not illustrated). Bus receiver 22 is communicably coupled to vehicle communication bus 18 and is configured to receive bus messages communicated between the various hybrid drive system components and subsystems of interest, as well as other communications of interest. Bus receiver 22 and processor 24 are illustrated separately, but may be integrated to form a single device or software application. Similarly, although the abovementioned functional units are illustrated separately, one or more may be combined together.

Here, bus 18 is illustrated as a single communication bus, however, it is understood that, especially with HEVs, bus 18 may represent multiple communication buses. In contrast to conventional vehicles, having for example a single bus (e.g., conforming to an OBD II standard), HEV's will often require multiple vehicle communication buses (e.g., controller area network (CAN) buses). For example, a HEV may retain the vehicle's traditional communication bus, but also require separate communication buses for the electric propulsion system, the propulsion energy storage, the power plant (e.g., engine), and a hybrid drive system integrating or master controller.

FIG. 2B, illustrates a more detailed block diagram of one embodiment of the vehicle communication bus of FIG. 2A. As discussed above, bus 18 may represent a communication bus network. In particular, bus 18 may include, for example, a dedicated hybrid propulsion/drive system communication bus 18A, a dedicated propulsion energy storage system communication bus 18B, a dedicated engine control communication bus 18C, a dedicated vehicle-only communication bus 18D, a dedicated non-vehicle (i.e., resident/hosted devices) communication bus 18E, and an integrating HEV communication bus 18F configured to integrate the HEV primary drive system, the energy storage, the engine, the vehicle components and subsystems, and the non-vehicle components and subsystems resident on the vehicle (e.g., passenger related services and/or monitoring). Each dedicated communication bus may then host a plurality of subsystems and components 13, 15, 16, 17, 19 (A to n) and controllers 14A, 14B, 14C, 14D, 14E as illustrated. Although one skilled in the art will immediately recognize the individual subsystems and controllers illustrated, it is understood that this illustrative listing is merely representative, and in no way limiting, as typical HEVs may have on the order of hundreds of communicating units. According to one embodiment, controllers 14A, 14B, 14C, 14D, 14E may function to process data, issue commands to various linked subsystems/components, and serve as a portal between the different communication buses 18A, 18B, 18C, 18D, 18E. In addition, according to alternate embodiments, the multiple communications buses 18A, 18B, 18C, 18D, 18E may be combined completely or partially with each other, having more or fewer controllers. Also, additional communication buses not shown may be included as part of the contemplated vehicle communication bus 18.

Returning to FIG. 2A and referring to the backend's functional components, RDS server 30 may include web server 31, data storage module 35, and one or more display units or user interfaces (not shown). Web server 31 may provide various functions, including management of both streamed vehicle data and vehicle data files to be stored. Files that are autopushed may be stored locally in RDS data storage 35 and/or forwarded to user device 40. User device 40 may include a RDS client module 41, GUI 50, and local user device data storage 45. In one embodiment, the RDS server or computer 30 and one or more user devices 40 may all be located at one facility, while in other embodiments, user devices 40 may be mobile user devices or user devices at different locations from RDS server 30.

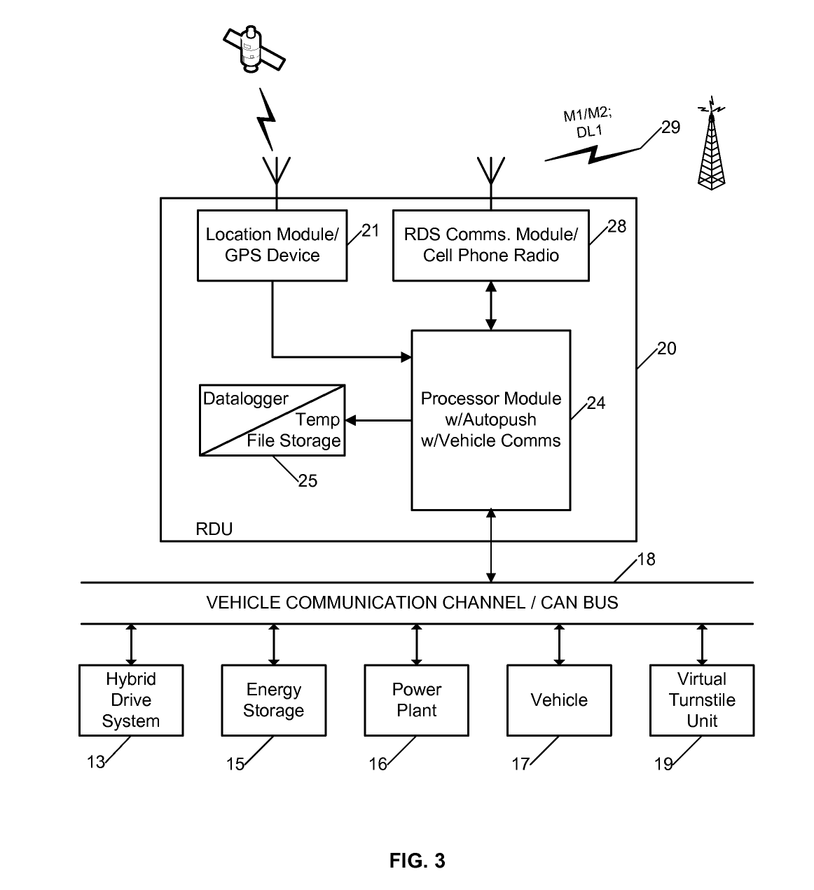

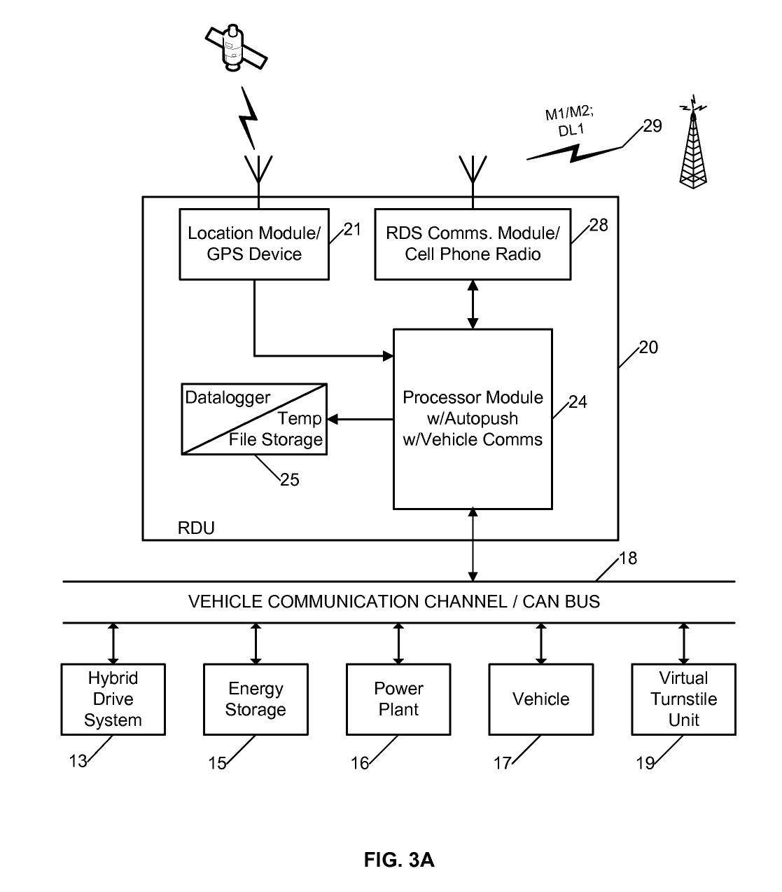

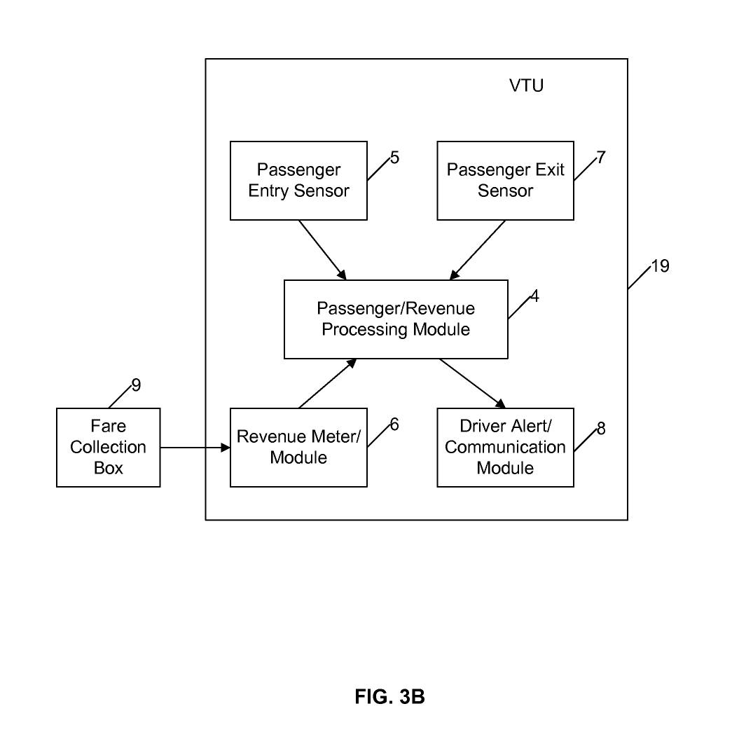

According to one embodiment, the RDU 20 may serve two primary functions. First, RDU 20 transmits hybrid drive system data communicated on the vehicle's communication bus 18, over the air, to the backend server 30, and ultimately to the user device 40. Generally, this vehicle data is streamed to the user device. It is understood that certain delays will be inherent in any communication scheme, but the transmissions intend to provide real time data reporting to a user. Second, the RDU 20 logs vehicle data. In particular, the RDU 20 sends data to be logged on RDS server 30 and/or user device 40. Generally, bus messages are packed as files, which are then transmitted to a remote storage 35, 45 when it is convenient to do so. According to an alternate embodiment, the RDU may log vehicle data locally in its own data storage (see e.g., FIG. 3A ref 25). Similarly, according to this embodiment, the RDS server 30 and/or user device 40 (collectively, the backend) may serve two primary functions. First, the backend reports hybrid drive system data to a user, substantially in real time. Second, the backend logs data on RDS server 30 and/or user device 40.

With regard to the system's first primary function (i.e., real time data), given the volume of typical hybrid drive system communication bus messaging, the data received is preferably reduced prior to transmission. In particular, the data may be filtered by message source and/or sampled in advance of transmission. For example, according to one embodiment, the bus receiver 22 and/or processor 24 may receive all messages communicated over bus 18, determine a set of message sources of interest, and only pass on messages from a predetermined set of message sources. Only messages from those predetermined sources will then be transmitted.

According to one embodiment, the message sources may be further filtered according to the anticipated usage. In particular, the message sources may be limited to the subsystems and/or components of interest to a particular type user, for example an engineer may require different information that a transit operator. Message source/data filtering may be preprogrammed and/or selectably determined by a user. As will be discussed below, the message source/data filtering may also be dependent on whether the vehicle is “selected” or “non-selected”.

In addition to filtering the message sources, the processor 24 may sample or otherwise limit the number of messages passed on or streamed to the server 30. For example, rather than transmitting multiple instances of nearly identical data (e.g., a constant energy storage state of charge (SOC)), processor 24 may only use data when it varies by a threshold amount (e.g., the SOC as it varies by >5%). Also for example, rather than transmitting every message communicated over the bus 18 (e.g., a “generator output setting” reported every 20 ms), processor 24 may only transmit data at a reduced rate (e.g., the “generator output setting” every 1 sec). In addition, it is understood that sampling may be further varied according to bandwidth or other communication link limitations. In addition, it is understood that sampling may also be dependent on whether the vehicle is “selected” or “non-selected”, as will be discussed below.

With regard to the system's second primary function (i.e., logged data), as mentioned above, massive amounts of information are communicated across vehicle communication bus 18 during HEV operation. While a more limited “snap shot” of filtered, sampled, and/or otherwise limited vehicle data may be sufficient for the real time reporting purposes, it is desirable to have a more in-depth data record logged. However, excessive resources would be required to deliver all the data over-the-air to the backend in real time, thus, it may be impractical to do so. Advantageously, the RDU's logging function becomes less time-sensitive when combined with its sampled/filtered real time reporting function. Accordingly, in this embodiment, RDU 20 may convert vehicle communication bus communications into compact files, and buffer them in the temporary file storage 23. Later, the files may be automatically transmitted via file autopush module 26 at convenient times and/or during favorable transmission conditions (e.g., during lulls in real time transmissions). Also, being packaged as files, the messages are more amenable to being temporarily stored and then forwarded to a remote data storage 35, 45. Furthermore, as discrete files, the data may be transmitted in recoverable groups, the wireless communication device 28 may transmit the data file directly to the remote location without post processing, and the received data may be easier to interpret and manipulate by a user on the backend.

FIG. 3A is a block diagram illustrating communication paths between an RDU and individual HEV subsystems/components via the vehicle communication channel 18 in each fleet vehicle 2, 3 of the system 100 of FIG. 1. According to one preferred embodiment, the RDU 20 includes a location module 21 (e.g., GPS device), a central processor or control module 24, a data storage module 25, and a RDS communication module 28 (e.g., cell phone radio). Here, the RDU 20 is configured to communicate with and/or “listen to” various vehicle components 13, 15, 16, 17, 19 via a vehicle wired and/or wireless communication network 18. In the illustrated embodiment, communication is via a controller area network (CAN) communication channel or vehicle communication bus 18.

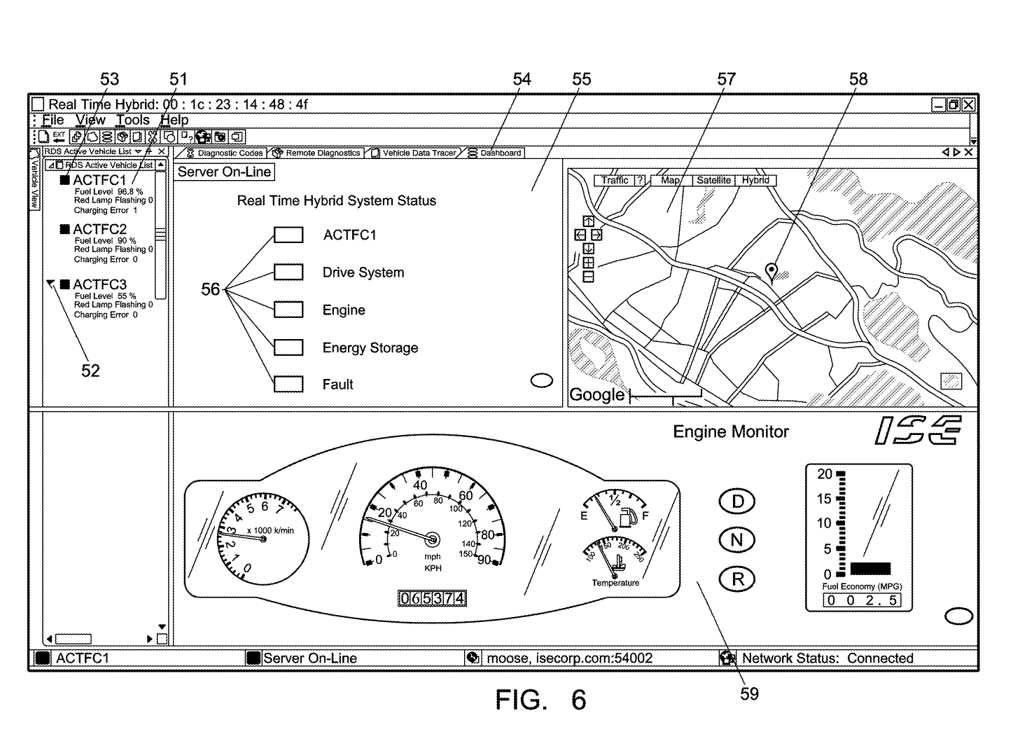

The various vehicle subsystems and components 13, 15, 16, 17, 19 may communicate with each other and provide status data to the RDU 20 via CAN bus 18. As discussed above, vehicle communication bus 18 may include multiple buses associated with the various vehicle subsystems and components 13, 15, 16, 17, 19. The vehicle components 13, 15, 16, 17 may include, for example, propulsion components (e.g., generator, electric motor, power inverter), energy storage and/or sensor components, engine operation sensors and/or components, vehicle air conditioning sensors or units, onboard computers, timers, and the like. Optionally, RDU 20 may communicate with both HEV components and non-vehicle components resident on the vehicle. For example, where the vehicles being monitored are passenger carrying vehicles such as transit buses, trolleys, trams, subways, and the like, one of the non-vehicle resident components which communicates with the RDU over CAN bus 18 may be a virtual turnstile unit (VTU) 19 that provides passenger and fare receipt data, and which is described in more detail below in connection with FIG. 6.

A variety of information may be received via the vehicle communication bus 18. Here, CAN bus 18 is in compliance with a standardized vehicle bus standard designed to allow microcontrollers and devices to communicate with each other throughout the HEV, and without a host computer. As such, messages may be received, processed, and stored by RDU 20 without directly connecting with the message's source. Moreover, RDU 20 may simply pass on messages without understanding or evaluating its content. Accordingly, RDU 20 may be in direct communication with a message source, may passively receive messages sent between a message source and a message recipient, or any combination thereof. Hybrid drive system messages may include information associated with any of the HEVs components and subsystems, including the electric propulsion system, power control, and electrical accessories. Also included are communications associated with the propulsion energy storage, the engine, and other vehicle systems. For example, with regard to the energy storage 15, RDU 20 may receive status information such as voltage values, current values, charge value, charge rate, cell charge over time, time to reach maximum voltage, rate of change of voltage, capacitance, lower charge voltage, upper charge voltage, set time out for charging each energy storage cell of the plurality of energy storage cells, capacitance, lower charge voltage, upper charge voltage, set time out for charging each energy storage cell of the plurality of energy storage cells, applied charge, cell voltage, charge time, temperature values, and the like. In one embodiment, other types of vehicle data received, processed, and/or stored by the RDU 20 include speed, fuel usage/economy, mileage, location information received from a positioning system such as the Global Position System (GPS) at GPS module 21, timing information generated or received by a timing module such as a clock device of the vehicle, passenger and/or fare collection information generated by VTU 19, and the like. The number of vehicle status information items collected and stored by the RDU may comprise up to 200 items or more.

In addition to collecting raw data from the various vehicle sensors and operational components 13, 15, 16, 17, 19, the location module 21, and the like, the RDU 20 may also be configured to process the received data in central processor 24 and/or an optional failure/fault processing module (not shown) in order to produce other useful information such as total number of passengers, fuel economy or efficiency, and actual or potential component failures or faults. Passenger and fare data may alternatively be processed by the VTU and communicated to the RDU, as described in more detail below.

Continuing with FIG. 3A and referring to the RDU 20, according to one preferred embodiment, storage module 25 provides temporary file storage as in FIG. 2A, but also provides local, persistent file storage or datalogging, similar to the abovementioned backend data storage devices 35, 45. Files logged on storage module 25 may be later downloaded manually by service personnel, and/or written over when storage capacity has been met. According to one embodiment, memory 25 is partitioned such that stored data files are segregated from temporary files that are awaiting autopush transmission to the backend. Onboard data logging is beneficial because file downloading to the backend may then be omitted or reduced, or in the alternate, backend file downloading may still be continued for redundancy or other purposes, but may be advantageously delayed until times where the vehicle is not in operation (i.e., streaming has ceased) and/or scheduled when maximum bandwidth is available (e.g., evenings).

Also, according to one preferred embodiment, the central processor 24 may be configured to receive, process, and/or log real time vehicle operation data from many different vehicle components 13, 15, 16, 17, as well as real time location data and turnstile data from VTU 19, and buffer the received data separately in data storage unit 25 for subsequent transmission to the RDS server 30 in designated status messages at predetermined time intervals. In addition, central processor 24 may integrate both a CAN bus receiver and an autopush function. Also, processor 24 may perform certain control functions on the RDU 20.

In operation, central processor 24 may access messages communicated over the vehicle communication bus 18. In particular, processor 24 may receive, filter, and/or sample messages transmitted by one or more sources over the vehicle communication channel 18. In addition, processor may receive messages or data that is communicated directly to it (e.g., GPS or clock data). Generally, only a subset of the total messages will be logged, and an even smaller subset of the total messages will be reported real time to a user. As such, processor 24 may filter and/or sample received messages twice, one for messages to be logged, and another for messages to be streamed. Moreover, the subset of messages to be streamed may vary, as will be discussed below.

Also, in operation, processor 24 interacts with the received messages. In particular, processor 24 may re-construct or otherwise process the received messages and their data. For example, processor 24 may re-construct the received messages by combining multiple messages into a single file. Likewise, processor 24 may segregate messages and/or files according to their final usage. For example, messages and/or files may be segregated based on whether they are destined for a local datalogger, to be autopushed to remote storage, to be streamed to a user device 40, etc. According to one embodiment, processor 24 may process received messages by accessing the data contained within the messages for further analysis such as comparison to predetermined thresholds or prioritize transmission. Additionally, where processor 24 has a fault/failure determination module (not shown), a fault/failure flag may be appended to the data and or to a file. In this embodiment, messages or files having fault/failure flags may be prioritized in their transmission.

With regard to logged data, and where processor 24 includes an autopush function, processor 24 may synch files stored on the local storage module 25 with a remote storage 35, 45. Synching of locally logged data at storage module 25 with a remote backend storage 35, on the RDS server 30 for example, may be controlled by the autopush application in processing module 24. During the autopush sequence, processor 24 may then retrieve logged vehicle data files or messages (“DL1”) from local storage 25 (or partition thereof) and transmit them to the backend storage 35. The RDS server communication module 28 controls the process of sending of the vehicle data file DL1 over the cell phone link 29. The web server 31 at the RDS 30 controls recording the data file on the server data storage 35 and/or forwarding it to user devices 40. As discussed above, recorded data or messages DL1 may be advantageously delayed until convenient times.

With regard to real time data, processor 24 may vary the RDU 20 configuration, depending on what messaging is required, for example, whether it is on a “selected” vehicle 3 or “non-selected” vehicle 2. In particular, processor 24 may cause RDU 20 to transmit at a first setting that reflects a user directly monitoring the HEV (i.e. “selected” vehicle 3), and a second setting that reflects the HEV being online, but not selected. For example, according to one embodiment, the RDU central processor 24 is configured transmit one or more predetermined status messages or vehicle data to the backend or server side of the system at predetermined intervals, with each message containing selected vehicle data or status items. For example, the predetermined time interval for messages may be every 60 seconds, although different intervals may be used in alternative embodiments. During these intervals, in addition to any communications associated with keeping the wireless link up, the processor 24 may send additional real time vehicle data, especially adding key status information (i.e., partial HEV messaging) to the RDU transmission of the “non-selected” vehicle 2.

Continuing with FIG. 3A, in one preferred embodiment, the RDU 20 is configured to send first and second real time status messages (“M1” and “M2”) at predetermined first and second time intervals (“T1” and “T2”), depending on whether the vehicle is “selected” or “non-selected”. In particular, the first status message M1 is transmitted only for “selected” active vehicles 3 at time interval T1, while only the second status message M2 being transmitted at the longer time interval T2 for “non-selected vehicles” 2. To illustrate, the first time interval T1 may be “fast” (e.g., every 500 milliseconds), and the second time interval T2 may be “slow” (e.g., every 60 seconds). It is understood that different time intervals may be used in alternative embodiments.

Alternately, both selected and non-selected vehicles 3, 2 may transmit the same messages at different rates or different messages at the same rates. In particular, according to one embodiment, first status message M1 may be transmitted for the one or more “selected” vehicles 3 at time interval T1, however, rather than creating a subset M2 of the M1 messages, the “non-selected” active vehicles 2 may be configured to transmit full M1 messages, but only at time interval T2, for display on the user interface or GUI 50. According to another embodiment, first status message M1 may still be transmitted for the one or more “selected” vehicles 3 at time interval T1, and a “partial” information status message M2 may be sent, however, at the same time interval as the “full” vehicle information status message M1 (i.e. T2=T1). In this way the non-selected vehicles 2 will have a quicker refresh rate. This may be particularly useful where M2 includes location or fault information.

According to another alternate embodiment, for the “non-selected” vehicles, a current first status message M1 may still be buffered in data storage 25 on the RDU 20, though not transmitted, so that current full information is readily available if one of the “non-selected” HEVs is subsequently selected for full or increased information display. As discussed above, partial information status message M2 preferably includes only a selected subset of information items for the vehicle. Any desired subset of the collected information items may be included in this message. Also, message M2 will preferably include a fault/failure flag.

Regarding message content, the first and second real time status messages M1 and M2 may contain vehicle information items drawing from substantially all available vehicle information received over the CAN bus, including status information on all vehicle components, along with the GPS information identifying vehicle position. Preferably, first real time status messages M1 may comprise substantially all available vehicle information received or information from substantially all vehicle message sources. This first message may be sampled down to accommodate any limitations of the wireless interface.

The second real time status message M2 may then contain a second group of vehicle information items or partial vehicle information (“key status information”), which may be a significantly smaller subset of the first status message. Typical status information reported in a partial status message M2 containing only partial or selected vehicle data may include one or more of:
a. Hybrid drive system fault/failure flag,
b. Propulsion Energy Storage Overvoltage,
c. Propulsion Energy Storage State of Health (SOH) or State of Charge (SOC),
d. Electrical System Isolation Resistance,
e. Vehicle Location, Speed, or Fuel Economy or average miles per gallon (mpg),
f. Number of Passengers or Vehicle Revenue,
g. Vehicle sensor output,
h. Status of particular vehicle components of interest such as generators, inverters, energy storage modules, electric motors, fuel cell, engine, and the like.

According to one embodiment, the partial vehicle status message sent by each RDU 20 may be a “fixed” or preset message having a predetermined subset of CAN and/or GPS data. For example the second message M2 may only include four data or key status information items such as vehicle location, speed, energy storage SOH, and high voltage system isolation.

Alternately, the partial status or second status messages M2 may include a user selectable subset of data items from a larger “menu” of CAN and GPS data (e.g., select subset of four from menu of twenty items). This is particularly advantageous where different type of users will be accessing the information. Accordingly, any other group of vehicle status information items may be selected by users and/or system controllers for reporting in the partial status messages M2, and different groups of information may be sent in message M2 to different user devices. To illustrate, in this embodiment each non-selected vehicle 2 may transmit a of 20 available message sources/data items to the RDS server 30, which are listed on a user device menu (e.g., numbered #1-#20). Using the menu on the user device 40, a first user may select items #1, #2, #3, and #18 to be reported via the GUI 50, while a second user may select #1, #7, #8, and #12. In response, the RDS server 30 then filters and reports the requested items in modified messages M2* to each respective user which each contain only the information items requested by that user. Another way would be for RDS server 30 to initially identify the requested items of the first and second users to the RDUs 20 of each non-selected, active vehicle. Then each non-selected vehicle 2 may transmit a reduced set of data items. For example, using the selected items above (i.e., #1, #2, #3, and #18 for first user, and #1, #7, #8, and #12 for second user), the RDS server 30 may request the non-selected, active vehicles to transmit items #: 1,2,3,7,8,12,18 in messages M2, which are forwarded to client devices 40. The client devices in turn may filter the information items to report or display items #1,2,3,18 in the first user's GUI and items #1,7,8,12 in the second user's GUI.

As discussed above, according to one embodiment, the partial or second status message M2 transmitted by the RDUs of active, non-selected vehicles may preferably include a system failure/fault flag in one data slot, but any remaining data slots may be modified by the user. In different implementations, the fault conditions could be determined by an onboard vehicle controller, the RDU 20, the RDS server 30, or even the RDS client device 41 or PC GUI. The RDU 20 or another on-board vehicle controller could also implement algorithms that predict a fault/failure based on historic information. Independent of the device that determines faults, once an out of tolerance condition is detected, remedial action may begin. For example, in the event the flag indicates a failure/fault, the system may provide an additional alert to the user. One such additional alert may include directing a request to the user asking whether he would like to select the failed/faulty vehicle for full RDS reporting. According to another embodiment, the system may automatically switch to the failed/faulty vehicle as the selected vehicle.

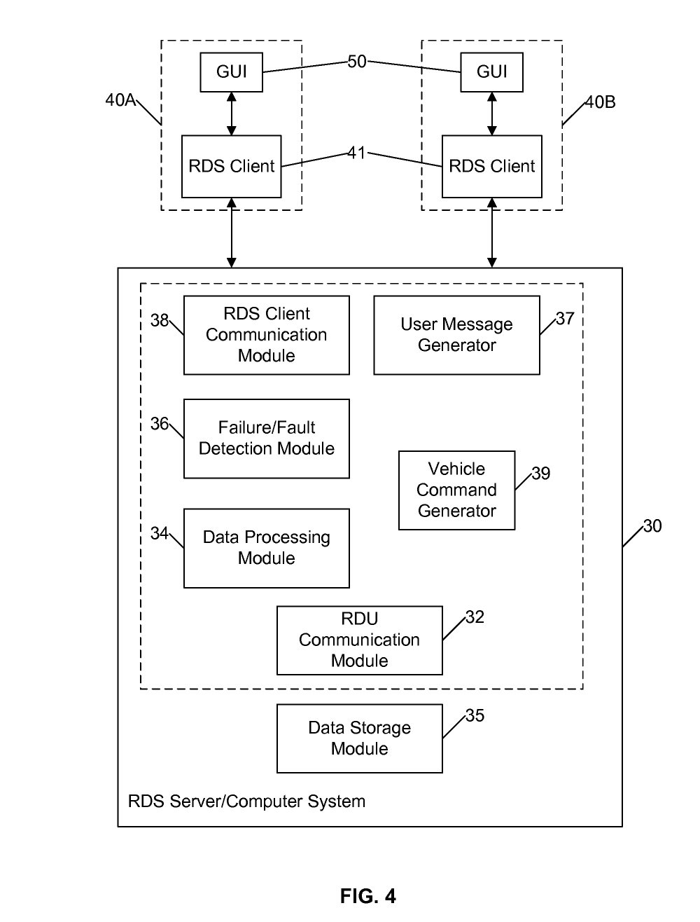

In addition to the ongoing reported messages, an initial status message, which may be a full or partial message (M1 or M2), is transmitted for all active vehicles upon start up. The initial message may be transmitted at the slow data rate, for example at time interval T2 (e.g., every 60 seconds). Alternately, this initial message may automatically, under certain specified conditions, be transmitted for one or more selected vehicles at a high data rate T1 (e.g., every 200 milliseconds). For example, when the vehicle is selected by a user at the backend, or when a fault or failure condition is recognized for that vehicle, the RDU 20 may automatically begin transmitting at the high rate T1. Thus, for such vehicles, the initial status message may be a first status message M1 that is transmitted at a high data rate T1. In either case, receipt of either message M1 or M2 indicates that the vehicle is currently online or otherwise operating. Thus, upon receiving either message, the RDS server 30 or RDS client device 41 may use it to generate a list of currently active vehicles in the user devices 40 currently registered to receive information for those vehicles, as described in more detail below in connection with FIGS. 4, 5, 6 and 7.

Non-vehicle components and subsystems may reside on, be powered by, and even communicate with the vehicles 2, 3. In embodiments where the vehicles 2, 3 are passenger carrying vehicles, each vehicle may include an optional virtual turnstile unit or VTU 19 which communicates current passenger and/or fare information to the RDU, as illustrated in FIG. 3A.

FIG. 3B is a more detailed block diagram of one embodiment of the virtual turnstile unit of FIG. 3A. As illustrated, VTU 19 basically comprises a processing module 4, a first sensor 5 that detects passengers entering the vehicle, a second sensor 7 that detects passengers leaving the vehicle, a fare collection module or revenue meter 6, and a communication module 8 that communicates passenger and fare receipt information to the RDU 20 over the CAN bus. The communication module 8 may also be configured to send driver alerts to the vehicle driver under certain conditions, such as detection of a passenger who has not paid a fare.

In alternative embodiments, simpler versions of the VTU may be arranged just to count passengers or just to count revenue generated by the vehicle. The VTU may communicate detection of a passenger entering (and optionally also a passenger leaving the vehicle or bus) over the CAN network. The VTU processing module 4 may also add each counted passenger to a total number and communicate the total number over the CAN network for transmission by the RDU 20 to the backend or server side of the remote monitoring and diagnostic system 100. Additional analysis and reports may be generated and provided by the RDU processor 24, the VTU processor, or a combination of both, such as:

1. Number of passengers entering per period of time (e.g. every thirty minutes).

2. Number of passengers entering per location (e.g. bus stop).

3. Number of passengers entering per time of day (e.g. at lunch time).

In embodiments where the VTU includes sensors both for detecting passengers entering 5 the bus or other passenger vehicle and for detecting passengers leaving 7 the bus, either the RDU 20 or the VTU 19 may use this information to calculate other statistics, including the number of passengers leaving per location, per time period, and per time of day, as well as the total number of passengers on the bus at any one time. This is valuable for system operators to determine the most popular routes and possibly to add or reduce service, based on passenger and revenue levels. The VTU generated information may also be useful for additional reasons such as safety and information gathering in the event of an accident.

The revenue meter or fare collection module 6 may be connected to a bus fare collection box 9 adjacent the bus driver and may be used in conjunction with the passenger detection sensors or in isolation. The revenue meter 6 may communicatively couple the bus fare collection box 9 to the CAN network, and thus to the RDU 20, and report fares collected by the bus 2, 3. In one embodiment, the passenger sensors 5, 7 may be omitted and the VTU 19 may alternatively use the revenue meter 6 to count passengers entering the bus. In this embodiment, the VTU 19 sends a message that a passenger has entered the bus upon detection of a fare received in the fare collection box. The backend server 30 or the onboard VTU 19 or RDU 20 may use this information to calculate passenger statistics such as those listed above in connection with the passenger sensors, e.g. passengers entering per hour, per bus stop, or per time of day, and to generate passenger and revenue status reports for all vehicles and routes.

According to another embodiment, the VTU 19 may determine a passenger count through passenger sensors 5, 7, and determine revenue through the revenue meter 6. With this information, the VTU 19, RDU 20, and/or RDS 30 may determine and report various additional vehicle statistics. For example, the VTU 19 may also report the dollar amount received when a passenger enters the bus. Further, the VTU 19 may correlate the fare with a class of passenger (e.g., handicapped, student, regular, etc.), and report that information as well. This information can be used by the end-user to make decisions related to bus usage.

In addition, this information may be presented along with the vehicle conditions on a GUI 50 at one or more user devices to help transit authorities evaluate the efficiency of a route, or to help fleet managers understand whether a vehicle's performance, or lack thereof, is related to an external condition such as the passenger load being carried.

In another embodiment, the VTU processing module or computer 4 may determine when a passenger enters the bus but does not pay a fare, e.g. when the passenger sensor detects a passenger entry but no fare collection is detected by the revenue meter or fare collection box. This comparison may result in an additional reported parameter such as number of revenue generating passengers. This information may be used to reconcile with end-of-day revenue information reported by the driver. Additionally, certain information may be fed back to a user on the backend and the bus driver. For example, when it is determined that a passenger has not paid, this information may be fed back to the passenger, the driver, and/or a manager in the form of an alert via driver alert module 8. An alert such as an audible alert may deter passengers from attempting to enter the bus without paying the fare, or may give them cause to return to the driver to pay the fare. The driver may also be provided with a reset button acknowledging, and thus approving, the passenger. The reset button is connected to the VTU processing module 4 and the input from this button may be used to add another fare-paying passenger to the total passenger count.

Feedback may be provided to a backend office in the form of a priority message. This message may be sent via the RDU 20 or through an independent communication. The system may trigger a command to be issued on receipt of certain messages or under certain conditions. In particular, upon detecting a passenger has entered the bus without paying a fare, this may trigger an onboard camera to record an image of the passenger entering. The processing module 4 may then process the image to determine whether a passenger did in fact enter the vehicle, thus providing a more reliable turnstile. Alternately, the recorded image may be saved for other purposes such as driver safety and/or fraud detection purposes. Upon payment of a fare, the camera may then delete the saved picture.

According to an alternate embodiment, the RDU may include information on “paying passengers” and/or alerts of non-paying passengers when continuously reporting basic/partial information of a fleet. This and other information may be presented to a user in a graphical format, as described in more detail below. The system may also incorporate “static” information such as the name of the bus driver or route.

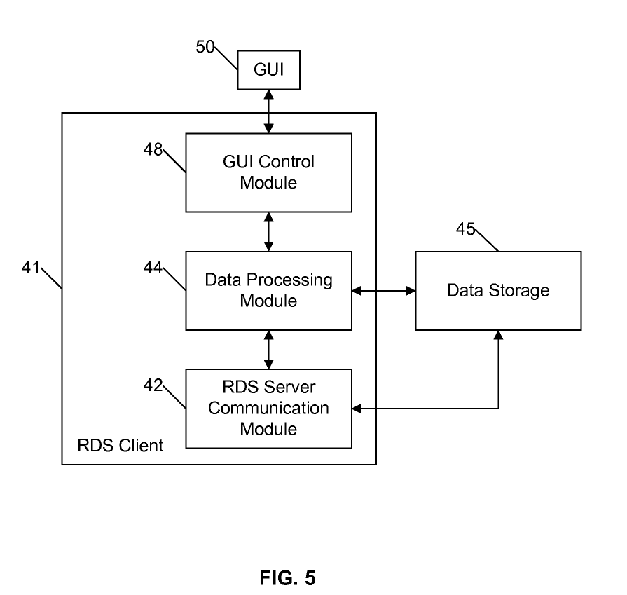

One embodiment of the backend or user/controller side of the system is illustrated in more detail in FIGS. 4 and 5. The system in one embodiment is a.NET based implementation comprising a web server application that provides graphical user interfaces 50 to remote user devices 40 (such as laptop computers, desktop computers, personal digital assistants (PDA), cell phones, or the like) over a network through a web browser on the user device, but other implementations may be used in alternative embodiments.

As illustrated in FIG. 4, the RDS server or computer system 30 basically comprises an RDU communication module or data receiving module 32 that receives first and second status messages M1, M2 from the RDUs 20 installed in fleet vehicles 2, 3, which are currently on-line, a data processing module 34 that processes the received data, a data storage module 35 that stores the received data along with program instructions, an RDS client communication module 38 that sends vehicle data to the user devices 40A, 40B authorized to receive the data, a vehicle command module 39 which sends commands to RDUs 20 via the RDU communication module 32, a user message generating module 37 that generates messages to users on the backend or server side of the system, and an optional failure/fault detection module 36 which analyzes incoming data to detect existing or potential vehicle faults or failures. Failure/fault detection module 36 may be, for example, a fault/failure detection system as described in co-pending application Ser. No. 11/273,387 (Patent Application Publication No. 2006/0149519) filed on Nov. 14, 2005. Alternatively, individual failure/fault detection modules may be installed in each vehicle in the fleet as part of the RDU 20 or as a stand alone module communicatively coupled to the other vehicle components over the CAN network.

The one or more displays or user devices 40A, 40B are configured with an RDS client 41 which may be software configured to display currently on-line vehicle information in a GUI 50 on, for example, a web browser, the vehicle information as generated by the backend server or computer 30 based on data received from the vehicles 2, 3, with the data being updated each time a new status message of any type for any of the listed vehicles is received. The partial and/or increased vehicle communication may be displayed on a web page supported by the remote server 30. The web page can be displayed on a remote user device 40A, 40B such as a computer system with a monitor, for example. In some embodiments, partial and/or increased vehicle communication may also be displayed in a GUI 50 on a computer screen associated with the server 30.

According to one preferred embodiment multiple user devices 40A, 40B may select different vehicles 3 via the central monitoring station 30. In particular, the selected vehicle 3 of user device 40A may be different from the selected vehicle 3 of user device 40B. Thus each vehicle be simultaneously a “selected” and “non-selected” vehicle 3, 2 and may communicate with the server so as to display different active vehicle information to multiple users in different locations. Here, both vehicles may transmit full messages M1 to the server 30, and the server 30 pass on the full message to one user device and only a subset of the full message to the other user device. Alternately, each RDU 20 may transmit both a full and partial message M1, M2 to the backend server 30.

In the case where there are multiple user devices 40A, 40B, it is preferable that access is managed by server 30. In particular, where not all users are authorized the same access, security measures may be included to limit/filter vehicle data that is not authorized to be used by a particular user. Access may be determined by comparing a user device's information against a library of authorized users and given the appropriate access.

FIG. 5 is a more detailed block diagram of one embodiment of the RDS client device installed in user devices of the system of FIG. 1. As illustrated, the RDS client 41 may comprise RDS server communication module 42, data processing module 44, and GUI control module 48 which controls the graphical user interface 50 displayed on a web page in the display screen of the user device. Similar to RDS client communication module 38, RDS server communication module 42 communicates with the server 30. Also, similar to the RDU's processor 24, data processing module 44 may route real time and logged data, may process the data, issue commands, and otherwise operate the user device 40.

In one embodiment, the user device 40 can also detect a fault or failure condition on the vehicle based on data contained in transmitted messages. The parameters needed to determine such a condition would stem from vehicle components that are nodes (or message sources) on the vehicle network(s) that the RDU 20 is connected to via CAN bus 18. The data processing module 44 may monitor and compare data against thresholds and take remedial action such as reporting and/or modifying RDU communications.

In one embodiment, where non-selected vehicles transmit a menu of selectable data, the RDS client 41 may be configured to control the GUI 50 to display only part of the information in each second status message M2 for a vehicle 2, 3, or all of the information, or may allow the user to select how much of the information in the second status message M2 is displayed. Similarly, where all vehicles only transmit first status messages M1 to all client devices 40, and the individual client devices 40 may be configured to control which information items are displayed. In particular, data processing module 44 may strip off all but the second message M2 information.

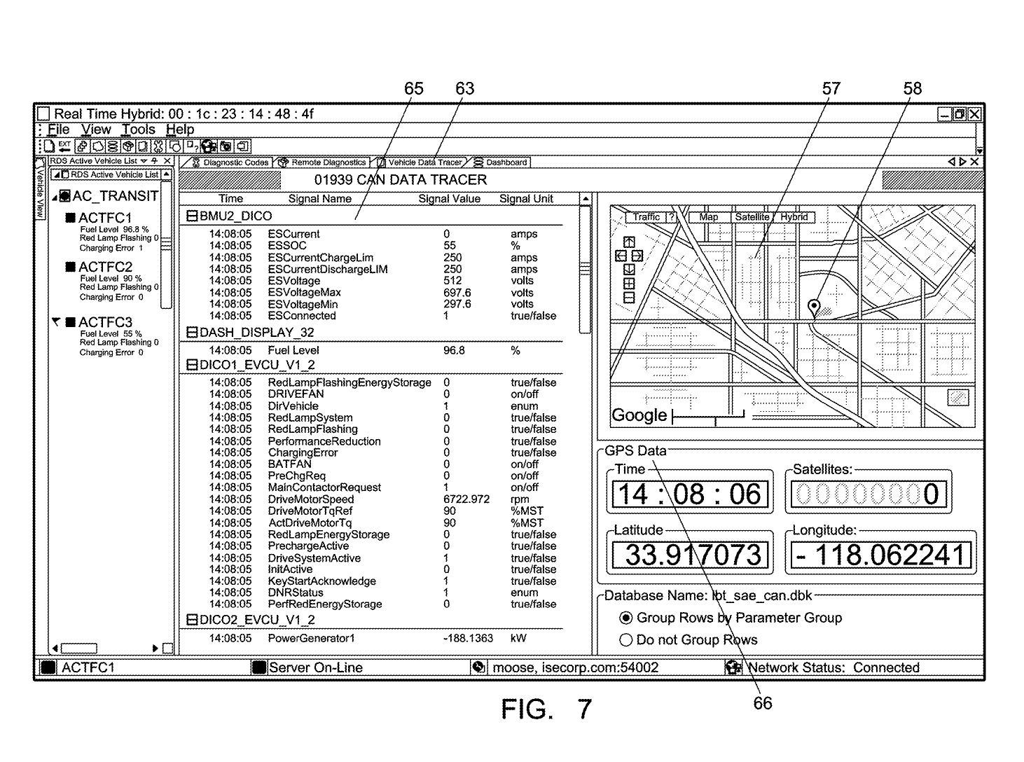

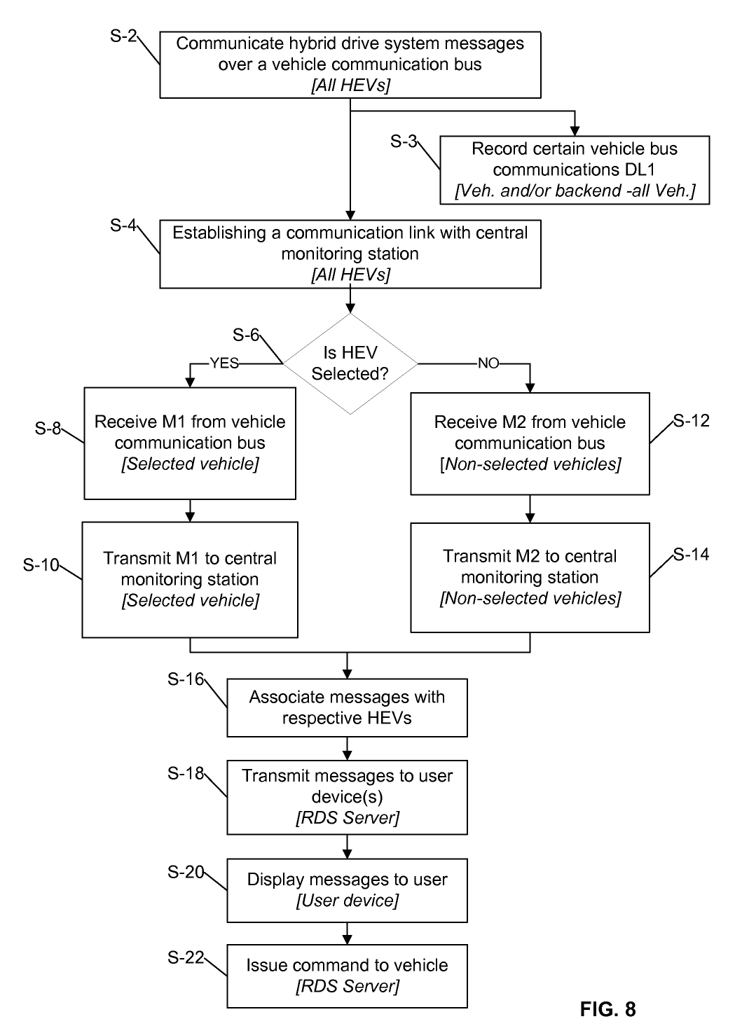

FIGS. 6 and 7 illustrate examples of a screen shot in a GUI 50 created by a client device or web server 40. The GUI 50 will generally include a list 51 in a side bar of all currently active vehicles in a fleet, along with associated partial status information for each vehicle. This list is continuously updated on receipt of new status messages. This list is also used to update the listed data, remove vehicles which are no longer active (i.e. status messages are no longer being received), and add any newly detected active vehicles (i.e. vehicles which have just started to send status messages). The user may select any desired vehicle in the list for display of more detailed information, and can choose different display modes or configurations, such as, for example, dashboard (FIG. 6) or full vehicle data/text display (FIG. 7).

In FIG. 6, the information displayed in the side bar list 51 includes a vehicle name or identifier for each active vehicle which the user is authorized to monitor (in this case ACTFC1, ACTFC2, and ACTFC3, although a greater number of vehicles may be displayed in other examples). Selected vehicle 3 may or may not be included in list 51. As discussed earlier, partial message M2 may include any information desired by the user. Here, for example, the partial information M2 displayed in the list 51 for each vehicle comprises fuel level, red lamp flashing, and charging error, as well as a flag 52. This partial information M2 is displayed next to the vehicle identifier of any of the vehicles 2 which have a detected failure or fault, or a potential failure or fault, as determined by a fault detection module which may be located anywhere in the system, such as in the vehicle itself, in the RDS server system, or in the user device. In the illustrated example, a vehicle fault/failure flag is displayed for vehicle ACTFC3.

In the screen shot of FIG. 6, the list 51 includes the selected vehicle 3 and the user has selected vehicle ACTFC1 for full information display, by clicking an icon 53 in the side bar alongside the vehicle name. A number of different display modes are available and may be selected by clicking one of the tabs along the top of the display screen. Here, the user has selected the tab 54 for Dashboard display. In this display, various vehicle systems are listed in system status area 55 along with tabs or boxes 56 alongside each system name which are in different colors based on the system status. For example, if the drive system, engine, and energy storage systems are all operating within normal range, the tabs 56 may be green. A fault condition is also listed under the vehicle system names, and the tab 56 alongside the fault indicator may be red if a fault or failure in any system has been detected. An area map 57 is displayed alongside the system status area 55, and includes an icon 58 indicating the current vehicle location. An engine monitor area 59 below areas 55 and 57 mimics the HEVs dashboard display of the fuel gauge, rpm, mph and other monitors on the vehicle dashboard, including current fuel economy.

In the screen shot of FIG. 7, the user has selected a full data display by clicking on Vehicle Data tab 63. The full vehicle status display for the selected vehicle may provide the user with complete CAN information, which can be viewed in region 65, with the user scrolling down to see the complete list of CAN information. As in FIG. 6, a map of the city or geographical area of fleet operation is displayed in region 57, with an icon 58 showing the current location of the selected vehicle using current GPS data. In one embodiment, the positions of non-selected, active vehicles may also be shown on the map in other icons (not illustrated) which may be a different color or otherwise distinguishable from the location icon 58 for the currently selected vehicle. Other GPS data may also be displayed in area 66 below the map 57. Other display modes may be provided, including a remote diagnostics display with more detailed information on the current condition of various vehicle components.

In one embodiment, the RDS server 30 or RDS client 41 may integrate the RDU reported information with non-vehicle data and/or third party data obtained off board the vehicle. Likewise, the additional status message data M2 of non-selected vehicles 2 may be simultaneously displayed or superimposed with the data of the selected vehicle. For example, in one embodiment, if “location” is included in the status message, the GUI map displaying the location of the selected vehicle may also display the location of non-selected vehicles where they are in the range of the map. Furthermore, the GUI 50 may display the following integrated information: a map of the city, all bus routes superimposed on the map, and an icon of each bus location along its respective route. The bus icon may also include some or all of the following data: the route number, the name of the driver, an image of the driver, the current number of passengers, and the like.

As discussed above, in one embodiment the RDUs of on-line or active vehicles transmit a partial data status message M2 containing selected CAN and GPS information items to the RDS, independent of the low rate, full CAN and GPS transmission of all vehicle data. Since the “presence data” (whether the vehicle is online) is only reported to the user interface at a longer time interval T2 such as every 60 seconds, the partial data status message need only be sent at time intervals T2 as well. The partial vehicle data may be displayed in the side bar or currently active vehicle list of FIGS. 6 and 7, or may be displayed in an icon of the vehicle position on the map 57, or both.

FIG. 8 illustrates a method for remotely monitoring a plurality of electric vehicle drive systems in the field. In general, the method is uses dissimilar real time transmissions between the plurality of vehicles and a central monitoring station such that all vehicles are transmitting vehicle communications, however, at least one selected vehicle is transmitting enhanced communications. In particular, all of the plurality of HEVs that are active or otherwise online will communicate hybrid drive system messages over a vehicle communication bus (S-2). Also, the HEVs will establish a communication link with the monitoring station (S-4). The wireless communication link may include a wireless communication link such as a cellular communications link. From the HEVs that have established communications with the central monitoring station, a user may direct the central monitoring station to select an HEV of interest as a “selected” vehicle (S-6). The at least one selected vehicle will receive a first subset (“M1”) of the real time hybrid drive system messages that are communicated over the vehicle communication bus (S-8). Preferably, this will include a sampling of the communicated messages from substantially all messages sources. As above, it is understood that the vehicle communication bus may include a communication network having multiple communication buses. In addition, while it is the intent to receive hybrid drive system messages, it is understood that other messages sources may also be included in bus communications (e.g., various vehicle components, drive system accessories, and resident systems). The at least one selected vehicle will then transmit the first subset of the hybrid drive system messages M1 to the central monitoring station for further processing (S-10). M1 transmissions may take place frequently at time intervals (“T1”).

Meanwhile, the “non-selected” vehicles will receive a second subset (“M2”) of the real time hybrid drive system messages that are communicated over the vehicle communication bus (S-12). As with the selected vehicle(s), this will include a sampling of communicated messages. However, in contrast, the second subset M2 will be substantially smaller than M1, and may only be associated with a predetermined subset of message sources, representing key status information. Key status information may be predetermined by the system and/or dynamically defined by the user and/or the system. The non-selected vehicles will then transmit the second subset of the hybrid drive system messages M1 to the central monitoring station for further processing (S-14). M2 transmissions may take place periodically at time intervals (“T2”), which may be less frequent that time intervals T1.

In both the selected and non-selected vehicles, the system will preferably record certain vehicle bus communications (S-15). The recorded messages (“DL1”) may include substantially all communicated messages, and may be recorded on the vehicle, on the backend, or both. Moreover, the recorded messages with be determined independent of whether the vehicle is selected or not. Recorded communications DL1 may be the same messages as transmitted real time as the first subset of messages M1, or may be the full, unsampled, M1 message group. Recorded messages DL1 may be combined into compact data files. Recorded messages DL1 may be recorded on the vehicle, on the backend, or both. However, where recorded messages DL1 are recorded on the backend, they will preferably be transmitted separately from the real time messages M1 and M2 and may be scheduled via an autopush algorithm.

At the backend, all messages transmitted will be associated with their respective source vehicle and further processed (S-16). Backend processing may include data logging (as in S-15), data analysis (e.g., failure/fault detection), forwarding to a user device (S-18), responding with control signals and or supplemental data. Where the messages are forwarded to a user device, both M1 and M2 messages may be displayed to the user simultaneously (S-20). Upon a request by a user and/or a determination by the system, a command may be issued to one or more vehicles (S-22). Preferably, the command will include selecting a new vehicle of interest and de-selecting a prior vehicle of interest responsive to vehicle data or key status information transmitted in M2 of the previously non-selected vehicle.

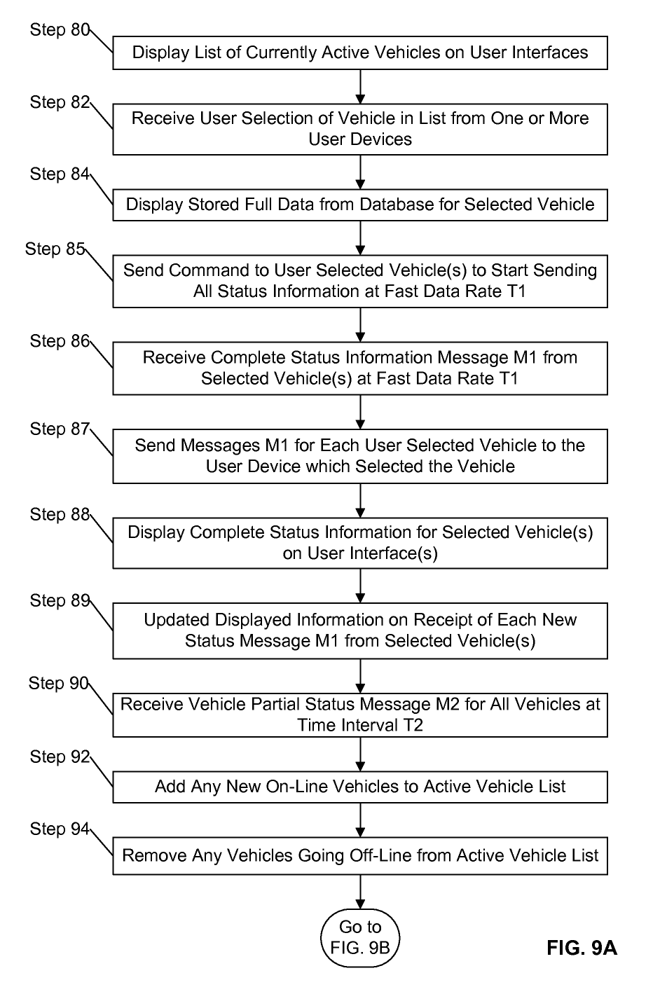

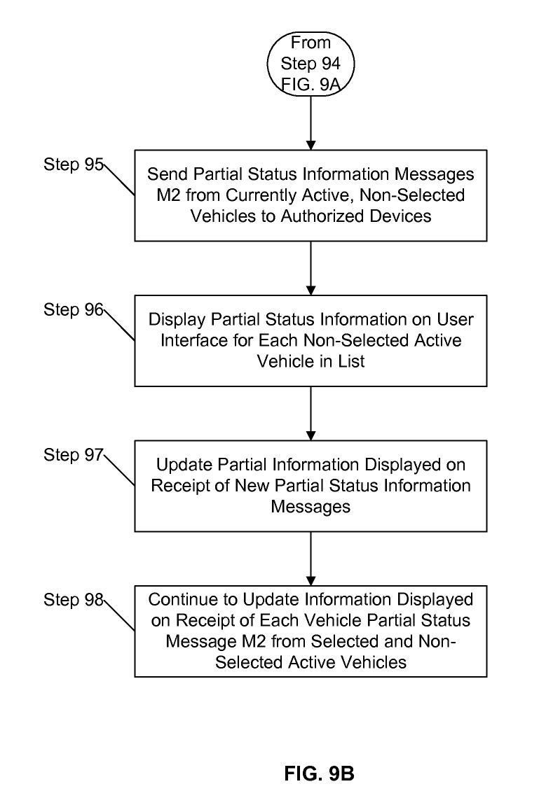

FIGS. 9A and 9B are flow diagrams illustrating one particular embodiment of a method of providing status and diagnostic information on active fleet vehicles to a user at a remote user device. As illustrated in FIG. 9A, the system is configured to display a list of identifiers or names of currently active or on-line vehicles 3 in the GUI (step 80). In one example, the list of currently active vehicles is displayed in a side bar, as illustrated in FIGS. 6 and 7. This information is determined from the first or second real time messages (M1, M2), which are sent from each active vehicle's RDU to the RDS server at a time intervals T1 or T2, respectively. T1 may be a fast data rate such as transmissions every 200 milliseconds, whereas T2 may be a slow data rate such as transmissions every 60 seconds. The data processor module 34 at server 30 or the RDS client 41 at the respective user device may then interpret receipt of messages M1 or M2 from a previously unlisted vehicle as an indication that the vehicle is currently active, so that the vehicle is added to the active vehicle list along with the associated data. When no further messages M1 or M2 are received from a listed vehicle after expiry of the predetermined time period, the RDS processor module 34 or the RDS client 41 may determine that the vehicle is no longer active and removes it from the list.

When a user selects a vehicle from the current active list for full data display (step 82), the most recent stored full data for that vehicle (obtained from the previously received complete CAN and GPS data messages DL1 sent by each active vehicle at during an autopush) may be retrieved from the data base either at the RDS server 35 or the user device 45 and displayed in the GUI (step 84) in a user selected mode or configuration, for example as illustrated in FIGS. 6 and 7. The user can select the display option from the tabs at the top of the screen, as described above. At the same time, a command may be sent to the user selected vehicle (step 85) to begin sending full data at a fast data rate T1, which may be every 0.5 seconds in one example. The RDS server then begins receiving full data messages M1 from the newly selected vehicle or vehicles at data rate T1 (step 86).

According to one embodiment, different user devices may select different vehicles as their respective “selected vehicle” for full display. This is particularly useful where multiple users are accessing a fleet and have different vehicles of interest. This is also useful when the central monitoring station 30 serves multiple users that are not authorized to monitor each other's fleets. Accordingly, the RDS server 30 filters incoming full data messages M1 from each user-selected vehicle and directs them to the appropriate user devices (step 87). In the latter case, where not all users are authorized the same access, security measures may be included to limit/filter vehicle data that is not authorized to be used by a particular user. Security measures may include user authentication (e.g., username and password) for example.

The GUI interface controller 48 at the respective user devices 40 then controls the GUIs to display selected or all vehicle information from messages M1 for the selected vehicle on the GUI (step 88), updating the display on receipt of each full data message (step 89). The full vehicle information continues to be updated on receipt of each full data message M1 while the vehicle is still selected and active. Vehicle information from active and selected vehicles may also be stored in the data storage module 45 in place of or in combination with any recorded messages or files DL1.

The RDS server 30 also receives updated partial or second messages M2 (key status information) for all currently active vehicles at a slower rate T2 (step 90). Each time a status message M2 is received, the currently active vehicle list is updated to add any newly active vehicles which have just started sending status messages M2 (step 92), or to remove any vehicles which have stopped sending status messages M2 (step 94), i.e. vehicles which have completed a trip or finished a duty cycle, are currently shut down, and/or are no longer transmitting. The list update of steps 92 and 94 may be carried out at the respective client devices 41 or at the RDS server 30. In the latter case, the RDS server 30 filters the data to provide a currently active vehicle list 51 to each user device which includes only the vehicles which the respective user device is authorized to monitor. This controls updating of the list of currently active vehicles displayed at step 80.

The RDS server 30 sends partial status information messages M2 received at a slow data rate T2 from all currently active or online vehicles to the user devices 40 authorized to receive information on the respective vehicles (step 95). Thus, the data processor 34 at the RDS server filters the messages M2 for each user device based on the vehicles which the respective user device 40 is authorized to monitor, which may be some or all vehicles in one or more fleets. The partial information or selected information items in messages M2 received at each user device 40 is displayed on the GUI 50 for that user device (step 96). The information items may be displayed in the active vehicle list adjacent the identification of the respective currently active vehicles, for example as illustrated in FIGS. 6 and 7, and may additionally or alternatively be displayed in icons on a map indicating the current location of each currently active vehicle (not shown). The partial information items for each active vehicle are updated each time a new partial status message M2 for the respective vehicles is received (step 97). The RDS system 30 then continues to update the GUI 50 for each new vehicle partial status message M2 received from currently active vehicles and each new complete status message M1 received for the currently selected vehicle at the user device 40, and to update the data storage 45 (if used) with new information for each vehicle (step 98).

In addition to controlling the display of vehicle status information on the user device 40 of each participating user, such as fleet operators, maintenance personnel, and the like, the RDS server 30 may also perform other tasks, such as processing or analyzing incoming information for any vehicle failures or faults, processing the data to provide other useful information for display on the GUI 50 or in reports, such as route profitability and passenger capacities, and providing commands or alert messages to both users and vehicle drivers.

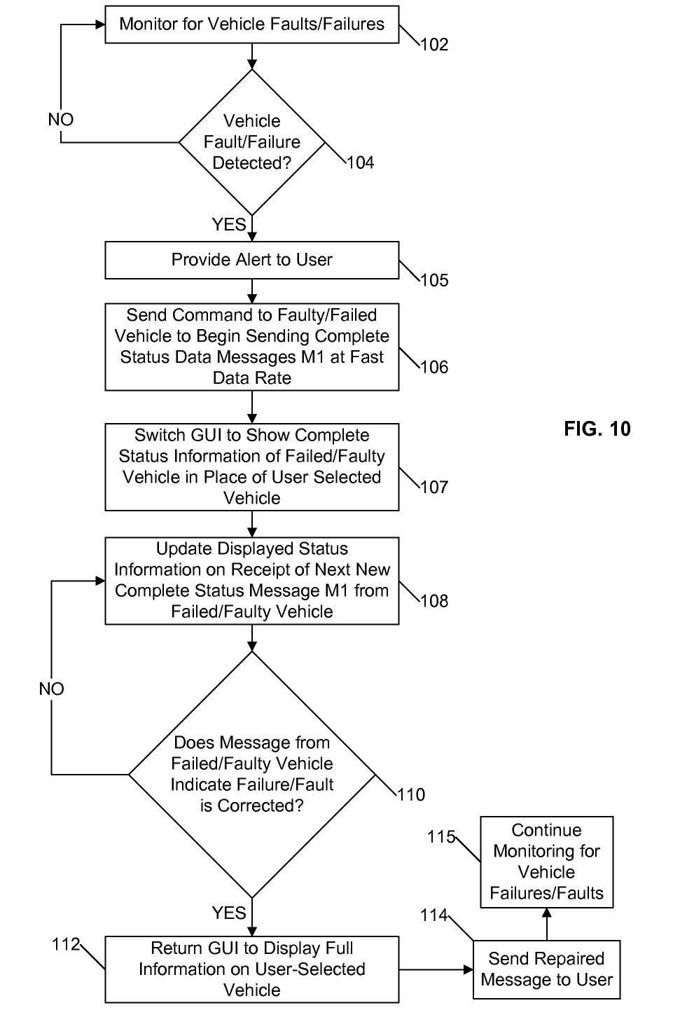

FIG. 10 illustrates a flow diagram of one embodiment of a method for monitoring for vehicle faults and failures. Both selected and non-selected vehicles may be monitored. Additionally, any selected part of the system, such as the RDU 20, the RDS server 30, or the client device 40 may be configured to continuously monitor for vehicle failures or faults (step 102). One way of doing this, as noted above, is to look for the failure/fault flag in incoming messages from RDUs 40, either at the RDS server 30 or at the individual client devices 40. In the event that the flag indicates a failure or fault (step 104), an additional alert may be sent to the user (step 105). Any current failure/fault flags are displayed 52 in the additional information in the active vehicle list 51, but the additional alert may prompt the user to take additional action such as starting a vehicle diagnostic procedure or contacting maintenance personnel. A command may also be sent to the failed/faulty vehicle to begin sending complete status information messages M1, or to start sending such messages at a faster data rate T1 (step 106). The graphical user interface GUI 50 may also optionally be switched automatically to the failed/faulty vehicle as the selected vehicle (step 107), so that the user or maintenance personnel see all data items associated with the components of that vehicle, for diagnostic purposes. Alternatively, a request may be sent to the user first, asking if they would like to select the failed/faulty vehicle for full reporting. The GUI status information for the failed/faulty vehicle is updated each time a new status message M1 is received from the vehicle (step 108). If a message indicates that the failed/faulty condition has been corrected (step 110), the GUI may be switched back to displaying information on the user-selected vehicle (step 112). A message or alert may be sent to the user to indicate that the fault/failure has been corrected (step 114), and the system continues to monitor for future failures or faults (step 115), repeating the procedure in FIG. 10 if a subsequent failure or fault is detected for any vehicle.

As discussed above, each RDU 20 or a separate vehicle controller may also be configured to detect any failures/faults or failure/fault messages, and the RDU 20 may be configured to automatically exit its default settings in the event of a detected failure or fault, and reconfigure itself to take one or more of the following actions:
1. Increase the transmit rate of the partial data status messages M2;
2. Transmit all available data, i.e. complete data messages M1, instead of partial data messages M2;
3. Send an independent Alert to the user with the status messages;
4. Send an independent Alert to one or more independent entities such as maintenance personnel over the RDU wireless link 29, e.g. to cell phones, emails or the like;
5. Increase the transmit rate for transmitted status messages;
6. Increase the sampling rate of the failed/faulty component or unit in the vehicle reporting the failure/fault condition;
7. Actively request specific predefined information from the failed unit over the CAN.

Alternatively, the RDS Server 30 or a user may detect a predefined failure/fault message, and command the RDU 20 to exit its default settings and perform any of the above actions. In addition, the RDS Server 30 may send a message to the user asking if he wants to expand the status message from the failed/faulty vehicle to include additional items from a list of all available items of interest. For example, if the status data indicates a coolant over-temperature condition, the backend system may offer to include coolant level, engine speed, and any other items that may be causing the over-temperature in the status message. Alternatively, the system may automatically reconfigure the RDU status message to include the information of interest.

In one embodiment, either the RDS server 30 or the vehicle RDUs 20, or both, are equipped with a diagnostic toolkit or failure/fault detection module, such as module 36 of FIG. 4. In addition to algorithms for predicting future failures or faults, this kit may include software for diagnosis and/or repair/reconfiguration of each individual component in the vehicle. Once a potential fault or failure is detected based on status information received over the vehicle CAN bus, the RDS points to the component and symptoms driving the error, and the diagnostic module may be used to further evaluate the condition and aid in repair.

With the arrangement described above, the remote diagnostic system is more accurate during fault conditions and provides for a quicker response time by users and maintenance personnel. This especially beneficial for hybrid electric vehicles having highly integrated electric drive system that may be more susceptible to transient faults than conventional vehicles and that and may include high voltage onboard energy and power control systems. Additionally, the RDU in combination with a VTU in the above embodiment provides revenue and route efficiency information useful for transit authorities and other fleet managers. The combined display of both hybrid drive system data, vehicle operational information, and passenger information allows easy access by users to all data of interest and allows them to easily monitor fleet performance and to identify faults and failures or potential faults and failures early, reducing maintenance response time. For example, where fuel economy data indicates that a particular vehicle is not performing at its expected economy level, the system may be reconfigured to send new performance parameters to adjust the engine or even configure the vehicle control software. In one embodiment, this may be done the next time the vehicle or bus is inoperative or shut down, i.e. outside normal operating hours.

This system also allows the remote diagnostic system to be tailored to suit the end-user's application, by allowing end users to select which information items are sent in periodic partial status messages M2 from RDUs or which information items from messages M2 are displayed in the GUI, and also allowing different users to receive different sets of information. For example, maintenance personnel may need operating information on various vehicle components, while fleet managers may want passenger and revenue information for route review purposes.

Those of skill will appreciate that the various illustrative logical blocks, modules, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block or step is for ease of description. Specific functions or steps can be moved from one module or block without departing from the invention.

Various illustrative logical blocks and modules described in connection with the embodiments disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

1. A method for remotely monitoring a plurality of hybrid-electric vehicle drive systems in the field, the plurality of hybrid-electric vehicle drive systems operating in a plurality of hybrid-electric vehicles, respectively, the method comprising:
in each of the plurality of hybrid-electric vehicles, communicating hybrid drive system messages over a vehicle communication bus;
establishing a communication link between each of the plurality of hybrid-electric vehicles and a central monitoring station, respectively, with each communication link including a wireless communication link;
selecting one of the plurality of hybrid-electric vehicles as a selected vehicle;
from the first selected vehicle, receiving a first subset of the communicated hybrid drive system messages associated with a first predetermined set of message sources;
from the first selected vehicle, transmitting the first subset of communicated hybrid drive system messages to the central monitoring station;
from each of the plurality of hybrid-electric vehicles that are not selected, receiving a second subset of the communicated hybrid drive system messages associated with a second predetermined set of message sources, the second predetermined set of message sources being smaller than the first predetermined set of message sources;
transmitting the second subset of communicated hybrid drive system messages, respectively, to the central monitoring station;
associating the first subset of communicated hybrid drive system messages and each second subset of communicated hybrid drive system messages with its respective hybrid-electric vehicle;
transmitting the first subset of communicated hybrid drive system messages and the second subsets of communicated hybrid drive system messages to a user device; and,
displaying the first subset of communicated hybrid drive system messages and the second subsets of communicated hybrid drive system messages on the user device.

2. The method of claim 1, wherein the receiving the first subset and the second subsets of the communicated hybrid drive system messages comprises sampling messages communicated over each hybrid-electric vehicle's vehicle communication bus, respectively.

3. The method of claim 1, wherein the transmitting the first subset of communicated hybrid drive system messages comprises transmitting the first subset of communicated hybrid drive system messages at a first transmit interval; and,
wherein each transmitting the second subset of communicated hybrid drive system messages comprises transmitting the second subset of communicated hybrid drive system messages at a second transmit interval, the second transmit interval being less frequent than the first transmit interval.

4. The method of claim 1, further comprising:
identifying a list of available message sources on the user device;
receiving a user selection of one or more available message sources, the user selection establishing a third predetermined set of message sources and an associated third subset of the communicated hybrid drive system messages;
issuing a command to at least one of the plurality of hybrid-electric vehicles that is not the selected vehicle, wherein the at least one of the plurality of hybrid-electric vehicles that is not the selected vehicle is commanded to transmit the third subset of communicated hybrid drive system messages to the central monitoring station.

5. The method of claim 1, further comprising:
comparing each of the second subsets of communicated hybrid drive system messages to a predetermined threshold;
determining that at least one of the second subsets of communicated hybrid drive system messages has exceeded the predetermined threshold, and identifying its associated hybrid electric vehicle as a beyond threshold vehicle; and,
issuing a command to the beyond threshold vehicle in response to the predetermined threshold being exceeded.

6. The method of claim 5 further comprising reporting the determination that the beyond threshold vehicle has exceeded the predetermined threshold to a third party remote from the user device.

7. The method of claim 5, wherein the issuing the command comprises commanding the beyond threshold vehicle to receive a third subset of the communicated hybrid drive system messages associated with a third predetermined set of message sources, and to transmit the third subset of communicated hybrid drive system messages to the central monitoring station at a third transmit interval, wherein the third transmit interval is more frequent than the second transmit interval.

8. The method of claim 7, wherein the third predetermined set of message sources is associated with and selected in response to the predetermined threshold exceeded.

9. The method of claim 7, wherein the issuing the command further comprises commanding the beyond threshold vehicle to record the received third subset of the communicated hybrid drive system messages.

10. The method of claim 7, wherein the issuing the command further comprises commanding the beyond threshold vehicle to record substantially all hybrid drive system messages communicated over the vehicle communication bus associated with the beyond threshold vehicle.

11. The method of claim 5, further comprising:
deselecting the selected vehicle;
commanding the deselected vehicle to receive the second subset of the communicated hybrid drive system messages;
commanding the deselected vehicle to transmit the second subset of communicated hybrid drive system messages to the central monitoring station; and,
selecting the beyond threshold vehicle as the selected vehicle; and,
wherein the issuing the command comprises commanding the beyond threshold vehicle to receive the first subset of the communicated hybrid drive system messages, and commanding the beyond threshold vehicle to transmit the first subset of communicated hybrid drive system messages to the central monitoring station.

12. The method of claim 5, further comprising requesting the user to authorize the issuing the command to the beyond threshold vehicle; and,
wherein the issuing the command to the beyond threshold vehicle is conditioned upon the user authorization.

13. The method of claim 1, wherein each of the plurality of hybrid-electric vehicles is configured to perform a self diagnosis and identify an associated status, the method further comprising:
from each of the plurality of hybrid-electric vehicles that is not selected, transmitting a status indication to the central monitoring station via each communication link with the central monitoring station, respectively;
comparing each of the status indications to a status threshold;
determining that at least one of the status indications has exceeded the status threshold, and identifying the associated hybrid electric vehicle as a beyond threshold vehicle;
issuing a command to the beyond threshold vehicle in response to the status threshold exceeded.

14. The method of claim 1, wherein the communicating hybrid drive system messages over a vehicle communication bus comprises communicating hybrid drive system messages over a controller area network (CAN).

15. The method of claim 1, further comprising:
receiving location information for each of the plurality of hybrid-electric vehicles separately from their respective controller area networks; and,
transmitting location information for each of the plurality of hybrid-electric vehicles to the central monitoring station via the communication link between each of the plurality of hybrid-electric vehicles and the central monitoring station.

16. The method of claim 1, wherein the receiving a second subset of the communicated hybrid drive system messages includes receiving an overvoltage indication of one or more onboard propulsion energy storage systems.

17. The method of claim 1, wherein the receiving a second subset of the communicated hybrid drive system messages includes receiving a low isolation resistance indication between one or more onboard electrical systems.

18. A hybrid drive system remote diagnostic unit in a hybrid electric vehicle, the hybrid electric vehicle including at least one vehicle communication bus configured to communicate messages between a plurality of hybrid drive system components and subsystems, the hybrid drive system remote diagnostic unit comprising:
a bus receiver communicably coupled to the vehicle communication bus and configured to receive bus messages communicated between the plurality of hybrid drive system components and subsystems across the at least one vehicle communication bus;
a wireless communication device communicably coupled with a central monitoring station and configured for full duplex communications;
a processor communicably coupled to the bus receiver and to the wireless communication device, the processor configured to receive commands from the central monitoring station, the processor further configured to selectably transmit a first subset of the received bus messages that are associated with a first predetermined set of message sources, or to transmit a second subset of received bus messages that associated with a second predetermined set of message sources, the second predetermined set of message sources being smaller than the first predetermined set of message sources, and wherein the received commands direct the processor whether to transmit the first or the second subset of the received bus messages.

19. The hybrid drive system remote diagnostic unit of claim 18, wherein the processor is further configured to dynamically reconfigure transmissions between transmitting at the first subset of the received bus messages and transmitting at the second subset responsive to a newly received command.

20. The hybrid drive system remote diagnostic unit of claim 19, wherein the processor is further configured to transmit the first subset of received bus messages at a first transmit interval, and to transmit the second subset of received bus messages at a second transmit interval, the second transmit interval being less frequent than the first transmit interval.

21. The hybrid drive system remote diagnostic unit of claim 18, wherein the processor is further configured to compare the received bus messages against a threshold and to transmit a status indication to the central monitoring station responsive to the comparison.

22. The hybrid drive system remote diagnostic unit of claim 18, further comprising a location device configured to provide location information to the processor.

23. The hybrid drive system remote diagnostic unit of claim 18, further comprising a datalogger configured to record the received bus messages.
